(19) United States
(12) Patent Application Publication
(10) Pub. No.: US 2025/0225337 A1
(43) Pub. Date: Jul. 10, 2025

(54) DETECTION OF HALLUCINATIONS IN LARGE LANGUAGE MODEL RESPONSES

(71) Applicant: GOOGLE LLC, Mountain View, CA (US)

(72) Inventor: Keun Soo Yim, San Jose, CA (US)

(21) Appl. No.: 18/408,320

(22) Filed: Jan. 9, 2024

(51) Int. Cl. G06F 40/40

(52) U.S. Cl. CPC G06F 40/40

(57) ABSTRACT

Implementations described herein relate to detecting hallucinations in responses generated by large language models (LLMs). A natural language (NL) based input associated with a client device may be received. A first LLM response may be generated based on processing the NL based input using an LLM. Based on processing the first LLM response, it may be determined whether the first LLM response contains at least one hallucination. Responsive to determining that the first LLM response contains at least one hallucination, a second LLM response may be generated based on processing the NL based input. It may be determined whether the second LLM response contains at least one hallucination, and, responsive to determining that the second LLM response does not contain at least one hallucination, the second LLM response may be caused to be rendered at the client device.

### BACKGROUND

Large language models (LLMs) are particular types of machine learning models that can perform various natural language processing (NLP) tasks, such as language generation, machine translation, and question-answering. These LLMs are typically trained on enormous amounts of diverse data including data from, but not limited to, webpages, electronic books, software code, electronic news articles, and machine translation data. Accordingly, these LLMs leverage the underlying data on which they were trained in performing these various NLP tasks. For instance, in performing a language generation task, these LLMs can process a natural language (NL) based input that is received from a client device, and generate an NL based output that is responsive to the NL based input and that is to be rendered at the client device.

Notably, these LLMs can be susceptible to hallucinations, such as when an LLM generates an output that is factually incorrect, nonsensical, and/or is not entirely responsive to the NL based input used to generate the output. For example, an LLM may process an NL based input of “Tell me the best landmarks to see in London” to provide an LLM output of “Buckingham Palace, the Houses of Parliament, the Eiffel Tower and the London Eye”. “Buckingham Palace”, “the Houses of Parliament”, and “the London Eye” are each landmarks that can be found in London and therefore appear to be valid responses to the NL based input, not indicative of a hallucination. However, the LLM output also includes a suggestion of “the Eiffel Tower”, which, not being found in London, is a factually incorrect response to the NL based input. It can therefore be seen that the LLM output contains a hallucination (i.e., “the Eiffel Tower”).

In some instances, a hallucination may be obvious to a user. In such instances the user, having identified the hallucination in the LLM output, may decide to submit a new NL based input to the LLM in an attempt to produce a new LLM output that does not contain a hallucination. However, submitting a new NL based input requires further steps to be taken by the user, which may result in a poor user experience. Even if an LLM has a low occurrence rate of generating hallucinations in its LLM outputs, the LLM may still be perceived as unreliable by the user. Such a perceived or actual unreliability may have a negative impact on the wider uptake and use of LLMs.

In other instances, it may not be obvious to a user that an LLM output contains a hallucination. In these instances, the user may assume that the LLM output is factually correct and/or fully responsive to the NL based input they provided to the LLM to generate the LLM output, and therefore the user may rely upon the LLM output in good faith. However, the presence of one or more non-obvious hallucinations in an LLM output may be problematic, for example, in instances wherein the LLM output is subsequently used as an input to another system for performing a technical task, such as controlling a robot. If the LLM output contains a hallucination, then the presence of the hallucination may result in incorrect or unexpected execution of the technical task.

An LLM can include hundreds of millions of parameters, billions of parameters, or even one hundred billion or more parameters. As such, given the large numbers of parameters included in an LLM, performance of NLP tasks using an LLM can consume relatively large amounts of resources (e.g., in terms of computing resources used in completing the NLP task, time taken to complete performance of the NLP task, energy consumed for completion of the NLP task, etc.).

Owing to the size of LLMs and the enormous amounts of diverse data they are trained on, it can be difficult to adequately train an LLM such that the occurrence of hallucinations is appropriately minimized. Such training may be considered impractical on account of the immense resources, time and costs that may be required. Moreover, it is not apparent that such training of an LLM can eliminate the generation of hallucinations altogether. It is therefore beneficial to provide an improved technique for addressing hallucinations in LLMs.

### SUMMARY

Implementations described herein can serve to mitigate the effects of hallucinations generated by LLMs. More specifically, implementations described herein relate to detecting hallucinations when utilizing an LLM to generate a response to an NL based input. The LLM can be used to process the NL based input to generate a candidate LLM response and the candidate LLM response may be processed to determine whether the candidate LLM response contains at least one LLM hallucination. Various techniques for determining whether the candidate response contains a hallucination may be used as described herein, alone or in combination. If it is determined that the candidate LLM response does not contain a hallucination, the candidate LLM response may be caused to be rendered, for example, at a client device.

However, if it is determined that the candidate LLM response does contain a hallucination, the LLM can be used to generate a new candidate LLM response, by processing the NL based input, or a modified version of the NL based input. Since the LLM operates in a probabilistic manner, the quality of the candidate responses generated based on processing the NL based input using the LLM can vary, as can the occurrence of one or more hallucinations in the candidate responses. Once a new candidate LLM response has been generated, it may be determined whether the new candidate LLM response contains a hallucination. The process of generating a new candidate LLM response and determining whether the generated candidate LLM response contains a hallucination may be repeated until a candidate LLM response is generated that does not contain a hallucination, at which point that candidate LLM response may be caused to be rendered at the client. Such techniques may result in responses being provided that reduce the number of follow-up NL based inputs provided by a user, at least on average across the user base. Although any given user may decide to provide a follow-up NL based input, any “on average” reduction in the number of follow-up NL based inputs can be hugely beneficial in terms of computational resource usage.

In some implementations, the LLM can be used to process the NL based input to generate a set of candidate LLM responses, the set of candidate LLM responses including a plurality of candidate LLM responses. Each candidate LLM response in the set of candidate LLM responses may be processed to determine whether it contains at least one hallucination, using any of the various techniques disclosed herein. If it is determined that one of the candidate LLM responses does not contain a hallucination, that candidate LLM response may be selected and caused to be rendered, for example, at a client device. If more than one of the candidate LLM responses is determined not to contain a hallucination, one of those candidate LLM responses that does not contain a hallucination may be selected for rendering. However, if it is determined that all of the candidate LLM responses contain at least one hallucination, the LLM can be used to generate a new set of candidate LLM responses, by processing the NL based input or a modified version of the NL based input. It may then be determined whether each of the new candidate LLM responses contains a hallucination. The process of generating a new set of candidate LLM responses and determining whether each of the candidate LLM responses contain a hallucination may be repeated until at least one candidate LLM response is generated that does not contain a hallucination, at which point that candidate LLM response may be caused to be rendered.

In these and other manners, hallucinations generated by an LLM can be reliably detected and mitigated. As such, instances of subsequent (e.g. follow-up) NL based inputs being provided by a user, e.g. in order to improve the quality of an initial response, which would otherwise be processed by the LLM can be reduced. Implementations which utilize one or more of the hallucination detection processes disclosed herein may ensure that resources, which would otherwise be consumed in these repeated interactions with the LLM, are conserved.

Furthermore, one or more implementations as described herein may provide LLM-agnostic methods for detecting and mitigating LLM hallucinations. In other words, the methods for detecting and mitigating LLM hallucinations may be used with a wide variety of different LLMs, with little or no adaptation of the LLM being required. Furthermore, by implementing hallucination detection outside of the LLM itself, implementations disclosed herein may allow for hallucinations in LLM responses to be detected and mitigated without necessarily performing costly, resource-intensive, and time-intensive training of the LLM to detect hallucinations.

In addition, in some instances, the hallucination detection process can be used as part of an NL based response system to be used for conducting a dialog (e.g., including multiple inputs and responses) with a human user. For instance, the NL based response system can be provided as part of an automated assistant, a chat bot, etc. In some cases, the user can provide an NL based input comprising one or more commands to be fulfilled as part of the dialog (e.g., to control a smart device, to generate code, to generate commands to control a robot, to assist with navigation in a vehicle, etc.). As such, use of the hallucination detection process described herein can also assist the user in performing a technical task by means of a continued and guided human-machine interaction process. Further, and since the responses generated using the LLM can be reliably of a higher quality, the human-machine interaction process can be concluded in a quick and efficient manner.

The above description is provided as an overview of some implementations of the present disclosure. Further description of those implementations, and other implementations, are described in more detail below.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2A depicts an example process flow for generating a response to a NL based input using an NL based response system, in accordance with various implementations.

FIG. 2B depicts an example process flow for generating a response to a NL based input using an NL based response system, in accordance with various implementations.

FIG. 3 depicts an example client device rendering a graphical interface that includes a response generated using an NL based response system, in accordance with various implementations.

FIG. 4 depicts an example client device rendering an audible output that includes a response generated using an NL based response system, in accordance with various implementations.

FIG. 5 depicts a flowchart illustrating an example method of utilizing an NL based response system to generate a response to an NL based input associated with a client device, in accordance with various implementations.

FIG. 6 depicts a flowchart illustrating an example method of utilizing an NL based response system to generate a response to an NL based input associated with a client device, in accordance with various implementations.

FIG. 7 depicts an example architecture of a computing device, in accordance with various implementations.

### DETAILED DESCRIPTION OF THE DRAWINGS

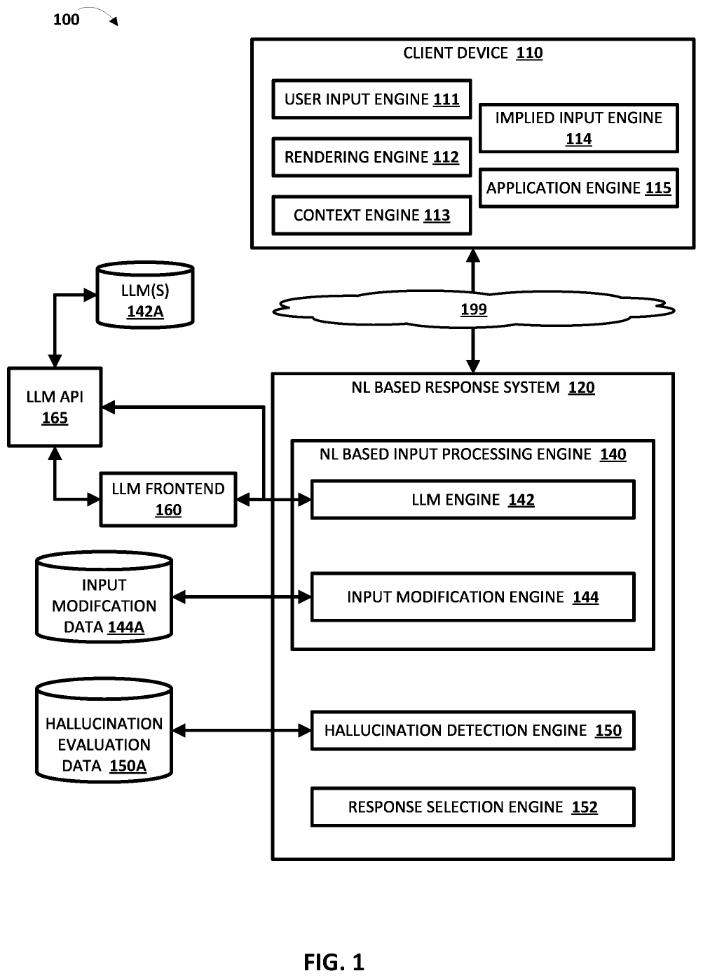

Turning now to FIG. 1, a block diagram of an example environment 100 that demonstrates various aspects of the present disclosure, and in which implementations disclosed herein can be implemented is depicted. The example environment 100 includes a client device 110 and a natural language (NL) based response system 120.

In some implementations, all or some aspects of the NL based response system 120 can be implemented locally at the client device 110. In additional or alternative implementations, all or some aspects of the NL based response system 120 can be implemented remotely from the client device 110 as depicted in FIG. 1 (e.g., at remote server(s)). In those implementations, the client device 110 and the NL based response system 120 can be communicatively coupled with each other via one or more networks 199, such as one or more wired or wireless local area networks (“LANs,” including Wi-Fi®, mesh networks, Bluetooth®, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 115, through which NL based input can be submitted and/or NL based output and/or other output that is responsive to the NL based input can be rendered (e.g., audibly and/or visually). The application engine 115 can execute one or more software applications that are separate from an operating system of the client device 110 (e.g., one installed “on top” of the operating system)—or can alternatively be implemented directly by the operating system of the client device 110. For example, the application engine 115 can execute a web browser or automated assistant installed on top of the operating system of the client device 110. As another example, the application engine 115 can execute a web browser software application or automated assistant software application that is integrated as part of the operating system of the client device 110. The application engine 115 (and the one or more software applications executed by the application engine 115) can interact with the NL based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch or typed input directed to the client device 110.

Some instances of an NL based input described herein can be a query for an NL response that is formulated based on user input provided by a user of the client device 110 and detected via user input engine 111. For example, the query can be a typed query that is typed via a physical or virtual keyboard, a suggested query that is selected via a touch screen or a mouse of the client device 110, a spoken voice query that is detected via microphone(s) of the client device 110 (and optionally directed to an automated assistant executing at least in part at the client device 110), or an image or video query that is based on vision data captured by vision component(s) of the client device 110 (or based on NL input generated based on processing the image using, for example, object detection model(s), captioning model(s), optical character recognition etc.). Other instances of a NL based input described herein can be a prompt for NL content that is formulated based on user input provided by a user of the client device 110 and detected via the user input engine 111. For example, the prompt can be a typed prompt that is typed via a physical or virtual keyboard, a suggested prompt that is selected via a touch screen or a mouse of the client device 110, a spoken prompt that is detected via microphone(s) of the client device 110, or an image prompt that is based on an image captured by a vision component of the client device 110.

In various implementations, the client device 110 can include a rendering engine 112 that is configured to render content (e.g., NL based response(s)) for audible and/or visual presentation to a user of the client device 110 using one or more user interface output devices. For example, the client device 110 can be equipped with one or more speakers that enable the content to be provided for audible presentation to the user via the client device 110. Additionally, or alternatively, the client device 110 can be equipped with a display or projector that enables the content to be provided for visual presentation to the user via the client device 110.

In various implementations, the client device 110 can include a context engine 113 that is configured to determine a context (e.g., a current or recent context) of the client device 110 and/or of a user of the client device 110 (e.g., an active user of the client device 110 when the client device 110 is associated with multiple users). In some of those implementations, the context engine 113 can determine a context based on data including, for example, user interaction data that characterizes current or recent interaction(s) of the client device 110 and/or a user of the client device 110, location data that characterizes a current or recent location(s) of the client device 110 and/or a user of the client device 110, user attribute data that characterizes one or more attributes of a user of the client device 110, user preference data that characterizes one or more preferences of a user of the client device 110, user profile data that characterizes a profile of a user of the client device 110 and/or any other data accessible to the context engine 113 via a database or otherwise.

For example, the context engine 113 can determine a current context based on a current state of a dialog session (e.g., considering one or more recent inputs provided by a user during the dialog session), profile data, and/or a current location of the client device 110. For instance, the context engine 113 can determine a current context of “best landmarks to visit in Lisbon” based on a recently issued query, profile data, and/or a current or an anticipated future location of the client device 110 (e.g., based on calendar information associated with the user accessible to the context engine 113). As another example, the context engine 113 can determine a current context based on which software application is active in the foreground of the client device 110, a current or recent state of the active software application, and/or content currently or recently rendered by the active software application. A context determined by the context engine 113 can be utilized, for example, in supplementing or rewriting NL based input that is formulated based on user input, in generating an implied NL based input (e.g., an implied query or prompt formulated independent of any explicit NL based input provided by a user of the client device 110), and/or in determining to submit an implied NL based input and/or to render result(s) (e.g., an NL based output) for an implied NL based input.

In various implementations, the client device 110 can include an implied input engine 114 that is configured to: generate an implied NL based input independent of any user explicit NL based input provided by a user of the client device 110; submit an implied NL based input, optionally independent of any user explicit NL based input that requests submission of the implied NL based input; and/or cause rendering of response(s) for the implied NL based input, optionally independent of any explicit NL based input that requests rendering of the response(s). For example, the implied input engine 114 can use one or more past or current contexts, from the context engine 113, in generating an implied NL based input, determining to submit the implied NL based input, and/or in determining to cause rendering of response(s) that is responsive to the implied NL based input. For instance, the implied input engine 114 can automatically generate and automatically submit an implied query or implied prompt based on the one or more past or current contexts. Further, the implied input engine 114 can automatically push the response(s) that is generated responsive to the implied query or implied prompt to cause them to be automatically rendered or can automatically push a notification of the response(s), such as a selectable notification that, when selected, causes rendering of the response(s). Additionally, or alternatively, the implied input engine 114 can submit respective implied NL based input at regular or non-regular intervals, and cause respective response(s) to be automatically provided (or a notification thereof automatically provided). For instance, the implied NL based input can be “automated assistant news” based on the one or more past or current contexts indicating a user's general interest in automated assistants, the implied NL based input or a variation thereof periodically submitted, and the respective response(s) can be automatically provided (or a notification thereof automatically provided). It is noted that the respective response(s) can vary over time in view of, e.g., presence of new/fresh search result document(s) over time.

Further, the client device 110 and/or the NL based response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices can be in communication with the client device 110 (e.g., over the network(s) 199). As another example, a given client device can be utilized by multiple users in a shared setting (e.g., a group of users, a household, a workplace, a hotel, etc.).

The NL based response system 120 is illustrated in FIG. 1 as including an NL based input processing engine 140, a hallucination detection engine 150, and a response selection engine 152. Some of these engines can be combined and/or omitted in various implementations. Further, these engines can include various sub-engines. For instance, the NL based input processing engine 140 is illustrated in FIG. 1 as including an LLM engine 142 and an input modification engine 144. Similarly, some of these sub-engines can be combined and/or omitted in various implementations. Accordingly, it should be understood that the various engines and sub-engines of the NL based response system 120 illustrated in FIG. 1 are depicted for the sake of describing certain functionalities and is not meant to be limiting.

Further, the NL based response system 120 is illustrated in FIG. 1 as interfacing with various databases, such as an LLM(s) database 142A, an input modification data database 144A, and a hallucination evaluation data database 150A. The NL based response system 120 may interface with the various databases via one or more wired or wireless networks (such as network(s) 199). Although particular engines and/or sub-engines are depicted as having access to particular databases, it should be understood that is for the sake of example and is not meant to be limiting. For instance, in some implementations, each of the various engines and/or sub-engines of the NL based response system 120 can have access to each of the various databases. Further, some of these databases can be combined and/or omitted in various implementations. Accordingly, it should be understood that the various databases interfacing with the NL based response system 120 illustrated in FIG. 1 are depicted for the sake of describing certain data that is accessible to the NL based response system 120 and is not meant to be limiting.

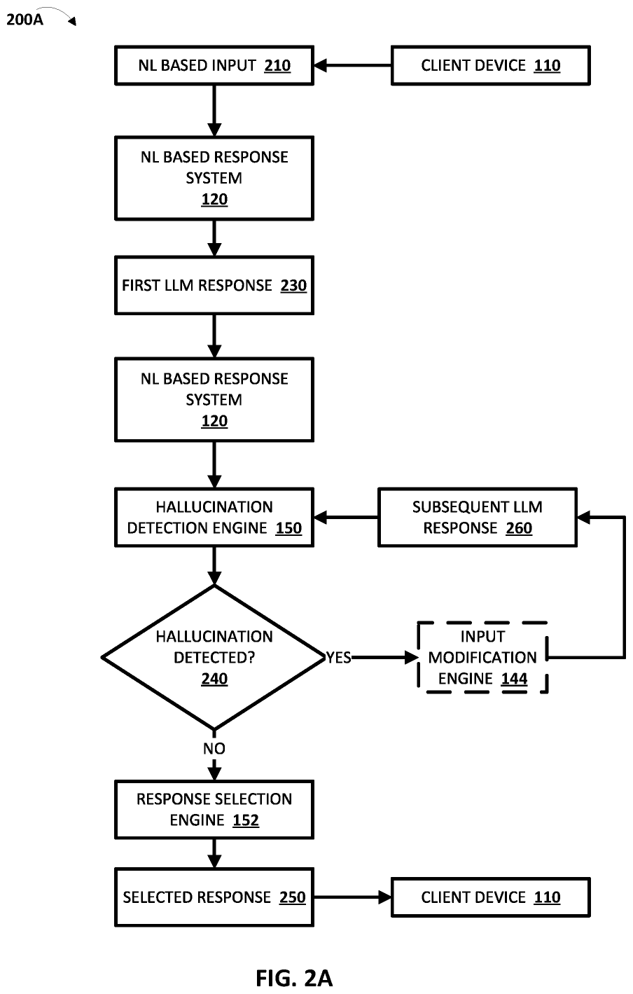

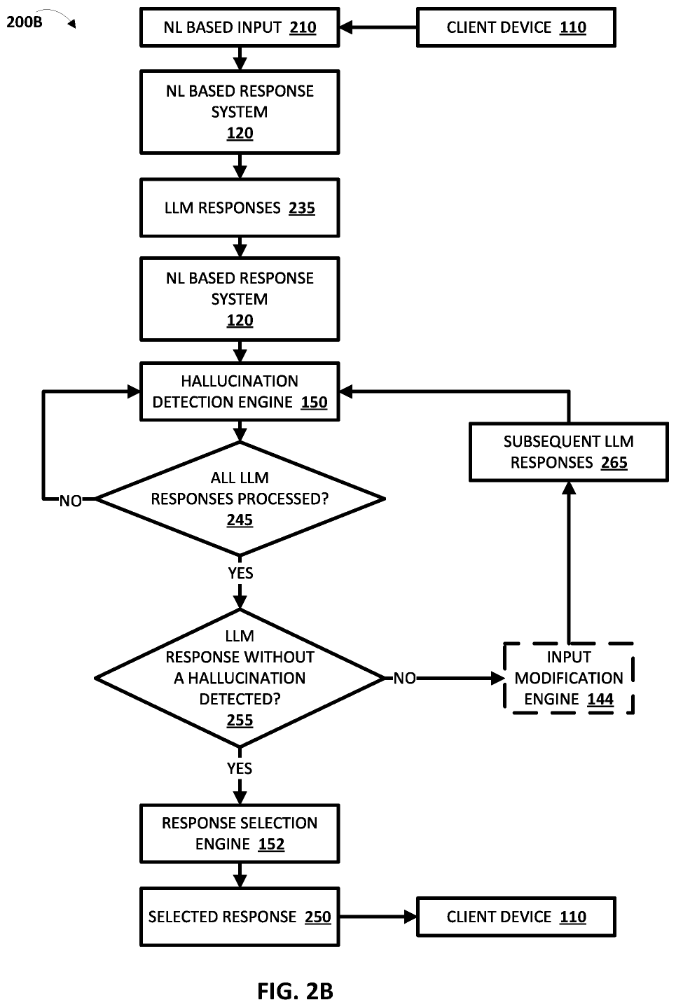

As described in more detail herein (e.g., with respect to FIGS. 2A-2B and 3-6), the NL based response system 120 can be utilized to generate one or more LLM responses based on an NL based input and to determine whether the one or more LLM responses likely contain a hallucination. The NL based input can be processed by the LLM engine 142, using an LLM stored in the LLM(s) database 142A, to generate one or more initial candidate LLM responses. The LLM can include, for example, any LLM that is stored in the LLM(s) database 142A, such as PaLM, BARD, BERT, LaMDA, Meena, GPT, and/or any other LLM, such as any other LLM that is encoder-only based, decoder-only based, sequence-to-sequence based and that optionally includes an attention mechanism or other memory.

In some implementations, the NL based response system 120 (e.g., the LLM engine 142 of the NL based response system 120) may interface with the LLM stored in the LLM(s) database 142A via an LLM frontend 160 associated with the LLM, wherein the LLM frontend 160 may communicate with the LLM via an LLM application programming interface (API) 165. As an example, the LLM frontend 160 may be implemented as a web-based service that is communicatively between the NL based response system 120 and the LLM API 165. Additionally, or alternatively, in some implementations the NL based response system 120 (e.g., the LLM engine 142 of the NL based response system 120) may interface directly with LLM API 165, that is, without interfacing with the LLM API 165 via an LLM frontend 160.

The one or more responses generated using the LLM can be processed by the hallucination detection engine 150, optionally using hallucination evaluation data stored in the hallucination evaluation data database 150A, to determine whether the one or more responses contain at least one hallucination. Based on the determination, one of the one or more initial responses determined by the hallucination detection engine 150 not to contain a hallucination can be selected by the response selection engine 152 for output. The NL based response system 140 may cause the response selected by the response selection engine 152 to be rendered, for example, at the client device 110 and using the rendering engine 112.

In some implementations, where the hallucination detection engine 150 instead determines that each of the one or more responses contain at least one hallucination, the NL based response system 120 may cause one or more subsequent (i.e., additional) LLM responses to be generated based on processing the NL based input using the LLM used to generate the previous LLM response(s) (or an alternative LLM stored in the LLM(s) database 142A). In some examples, the one or more subsequent LLM responses may be generated by processing the same NL based input used to generate the initial candidate responses. In other examples, the one or more subsequent LLM responses may be generated by modifying the NL based input using the input modification engine 144, such as by using input modification data stored in the input modification data database 144A, and processing the modified NL based input using the LLM (or the alternative LLM) to generate the one or more subsequent LLM responses.

In these implementations, the one or more subsequent LLM responses can be processed by the hallucination detection engine 150, for example in the same or similar manner as the previous one or more responses, to determine whether the one or more subsequent LLM responses contain at least one hallucination. Based on the determination, one of the one or more subsequent LLM responses determined not to contain a hallucination can be selected by the response selection engine 152 and caused to be rendered, for example at the client device 110.

In some implementations, where the hallucination detection engine 150 instead determines that each of the one or more subsequent LLM responses contains a hallucination, the NL based response system 120 may again generate new subsequent LLM responses based on the NL based input (or a modified version thereof) and determine whether those new subsequent LLM responses contain hallucinations, in order to find a response that does not contain a hallucination. The process of generating and processing subsequent LLM responses may be repeated until one or more termination criteria are met. For example, a first termination criterion may be that a response that does not contain a hallucination is detected. A second termination criterion may be that a predetermined number of iterations of generating responses (e.g. three iterations) has occurred. Other termination criteria may exist.

The hallucination detection engine 150 is separate from the LLM(s) used to generate the LLM responses (i.e., the hallucination detection engine 150 is not part of the LLM(s), nor does it include the LLM(s)). As such, the hallucination detection engine 150 may be configured to determine whether an LLM response generated using the LLM contains at least one hallucination without further using the LLM. This may be beneficial in that the detection of hallucinations may be tailored (e.g. to different types of tasks that are to be performed by the LLM) by adapting hallucination detection techniques performed by the hallucination detection engine 150, rather than by training the LLM or performing introspective operations on the LLM.

The NL based input can be associated with a client device 110 (for instance, provided by a user of the client device 110 via user input engine 111, implied input engine 114, etc.), and the NL based response system 120 (e.g., the response selection engine 152) can be used to select a particular response to be rendered (e.g., using rendering engine 112) at the client device (e.g. as described with respect to FIGS. 2A, 2B, 3, 4, 5 and 6).

Turning now to FIG. 2A, an example process flow 200A for generating a response to a NL based input using an NL based response system (e.g., the NL based response system 120 from FIG. 1) is depicted.

As discussed herein, an NL based input 210 can be obtained. For instance, the NL based input 210 can be provided based on user input by a user of a client device (e.g., the client device 110 from FIG. 1). The user can provide the user input, for instance, by typing on a virtual or physical keyboard of the client device 110, by providing speech which is captured by one or more microphones of the client device 110, by selection (e.g., via tapping on a touch screen display, voice command, using a pointing device, etc.) of a suggested input, by providing gestures captured by one or more sensors of the client device 110, etc. Information indicative of the user input can be used to determine the NL based input 210. For instance, the information can include text entered, selected, and/or determined based on processing the user's speech using speech recognition. This text can then be provided as the NL based input 210. As another example the information can include one or more token(s) which can be used to determine the NL based input 210 (e.g., by the client device 110 or the NL based response system 120). The information can be provided to the NL based response system 120 by the client device 110, for instance via a network (such as network 199).

The NL based input 210 can be provided to the NL based response system 120 in order to obtain an LLM response that is responsive to the NL based input 210. For instance, the NL based input 210 can include a query or a prompt. In some implementations, the NL based input 210 can include an intent to complete a particular task (that corresponds to a particular task type), for instance, to be fulfilled by an automated assistant (in some instances also known as a chat bot) that is communicatively coupled to the NL based response system 120 (e.g., via the network(s) 199).

The NL based input 210 can be processed using the NL based response system 120. More specifically, the NL based response system 120 (e.g., the LLM engine 142 of FIG. 1) can generate a first LLM response 230 (e.g., first candidate LLM response) based on processing the NL based input 210 using an LLM (e.g., an LLM stored in the LLM(s) database 142A of FIG. 1).

In some examples, the NL based response system 120 (e.g., via the LLM engine 142 of the NL based response system 120) may generate the first LLM response 230 by sending a request comprising the NL based input 210 to an LLM API (e.g., LLM API 165 of FIG. 1) associated with the LLM. As an example, the LLM API may comprise a remote procedure call (RPC) API or a RESTful API. The request sent to the API can be converted by the API into a query corresponding to the NL based input 210, which query can be sent to the LLM. Responsive to receiving the query, the LLM is caused to process the NL based input 210 to generate one or more LLM responses that are responsive to the NL based input 210, and to output the generated one or more LLM responses to the NL based response system 120 via the LLM API, wherein the one or more LLM responses comprise at least the first LLM response 230. In other examples, the NL based response system 120 may generate the first LLM response using an LLM that is local to a client device (e.g., an on-device LLM that is local to the client device 110).

In some implementations, the LLM and the LLM API may be configured to generate and provide to the NL based response system 120 a single LLM response (e.g., only generate and provide a first LLM response 230) for each NL based input 210 that is provided to the LLM.

In other implementations, the LLM API and the LLM may be configured to generate and provide to the NL based response system 120 a plurality (e.g. a set) of LLM responses that are responsive to any given NL based input 210 provided to the LLM. In such implementations, at least one of the LLM and the LLM API may optionally also generate and provide to the NL based response system 120 a respective quality score for each response of the plurality of responses, wherein the quality score is indicative of a quality of the respective response (e.g., indicative of a responsiveness of the response to the NL based input 210).

In implementations where the LLM and LLM API generate and output a plurality of candidate LLM responses to the NL based response system 120 that are responsive to the NL based input 210, the NL based response system 120 may select one of the plurality of responses as the first LLM response 230 using any suitable technique. For example, the NL based response system 120 may select the first of the plurality of responses that are output via the LLM API as the first LLM response 230. In other examples, the NL based response system 120 may select the first LLM response 230 based on a quality of each of the plurality of candidate LLM responses (e.g. based on the respective quality scores of the plurality of responses, for example by selecting the LLM response with the highest quality score as the first LLM response 230). In other examples, the NL based response system 120 may perform a random or pseudo-random selection of the plurality of responses to select the first LLM response 230. In some examples, the NL based response system 120 may filter the plurality of responses based on one or more predetermined criteria (such as response length or response tone) and select one of the filtered LLM responses as the first LLM response 230. It should be understood that these techniques for selecting one of the plurality of candidate LLM responses as a first LLM response 230 are provided by way of example and are not meant to be limiting. Rather, additional, or alternative techniques for selecting one of the plurality of candidate LLM responses as a first LLM response 230 may be implemented.

In some implementations, rather than generate the first LLM response 230 by sending a request comprising the NL based input 210 directly to an LLM API associated with the LLM, the NL based response system 120 may instead generate the first candidate response 230 by sending the NL based input 210 to an LLM frontend (e.g., LLM frontend 160 of FIG. 1) associated with the LLM, wherein the LLM frontend may communicate with the LLM via the LLM API to generate the one or more candidate LLM responses. In some examples, the LLM frontend may be implemented as a web-based service that is between the NL based response system 120 and the LLM API. The NL based response system 120 (e.g., via the LLM engine 142 of the NL based response system 120) may generate the first LLM response 230 by sending the NL based input 210 to the LLM frontend, which in turn can generate a request comprising the NL based input 210 and send the request to the LLM API. The request sent to the LLM API can be converted by the LLM API into a query corresponding to the NL based input 210, which query can be sent to the LLM. Responsive to receiving the query, the LLM is caused to process the NL based input 210 to generate one or more LLM responses that are responsive to the NL based input 210, and to output the generated one or more LLM responses to LLM front end. The LLM frontend can in turn provide the received one or more candidate LLM responses to the NL based response system 120. In some instances, at least one of the LLM frontend, the LLM API and the LLM may be configured to generate and provide to the NL based response system 120 a respective quality score for each response of the plurality of responses, the quality score being as described previously, for example.

In implementations where the LLM and the LLM API are configured to provide a plurality of candidate LLM responses to the LLM frontend, the LLM frontend may select one of the plurality of candidate LLM responses as the first LLM response 230 for providing to the NL based response system 120. The LLM frontend may perform the selection using any suitable technique, for example one or more of the techniques described previously for selecting a first LLM response 230. As an example, the LLM frontend may select as the first candidate response 230 the first of the plurality of responses that is output by the LLM API, the highest quality response that is output by the LLM API (for example based on a quality score for each response of the plurality of responses, the quality score generated by the LLM, the LLM API or the LLM frontend), a randomly or pseudo-randomly selected response from the plurality of responses, etc. Additionally, or alternatively, the selection of one of the plurality of candidate LLM responses as the first LLM response 230 may be performed by the LLM API and/or the NL based response system 120.

Since LLMs can be described as being probabilistic, each candidate LLM response generated by the LLM can differ from another candidate LLM response generated by the LLM, despite being generated based on the same NL based input 210. As such, it can be assumed that the extent to which a candidate LLM response generated by the LLM is actually responsive to the NL based input 210 will vary, as may the occurrence of one or more hallucinations in the LLM response. The first LLM response 230 can be evaluated by the NL based response system 120 using the hallucination detection engine 150 to determine at block 240 whether the first LLM response 230 contains one or more LLM hallucinations (also known as hallucination errors).

There are various types of LLM hallucinations that may be present in an LLM response, such as the first LLM response 230, and that may be detected by the hallucination detection engine 150. Hallucinations may be classified into, for example, two main types with each having various sub-types. A first type of hallucination is a superfluous information hallucination. This occurs when an LLM response contains superfluous information that is not responsive to the NL based input 210 processed to generate the LLM response, for example, because the superfluous information was not referred to and/or requested in the NL based input 210 and/or because the superfluous information is nonsensical or false.

An example of a sub-type of superfluous information hallucination is a superfluous annotation hallucination, where the LLM response includes an undesired or unnecessary annotation (e.g., where an LLM response is unnecessarily prefixed with “Here's the summary of your request:” or “This is my answer to your question.”). Another example of a sub-type of superfluous information hallucination is an explicit speaker hallucination, where the LLM response explicitly refers to the user that provided the NL based input 210 (or another speaker alluded to in the NL based input 210) (e.g., when the LLM response includes “You can [ . . . ]” or “Sarah [ . . . ]”). Another example of a sub-type of superfluous information hallucination is an incorrect tense hallucination, where the LLM response is provided in an incorrect tense for responding to the NL based input 210, for example, where a tense of the LLM response does not match a tense of the NL based input 210 (e.g., the NL based input 210 may state, in the past tense, “What was the weather like last November?” but the LLM response may state, in the present tense, “The weather will be sunny”, therefore the LLM response contains an incorrect tense hallucination). Another example of a sub-type of superfluous information hallucination is a superfluous facts hallucination, where the LLM response includes one or more facts that are not pertinent to the NL based input 210 (e.g., when an LLM response to an NL based input 210 of “What is the best car to buy in 2023?” includes non-pertinent information related to “boats”). Another example of a sub-type of superfluous information hallucination is an illogical hallucination, where the LLM response contains contradicting words or statements or contains another form of logical fallacy (e.g., when an LLM response states that “The young elephant was very old”).

A second type of hallucination is a missing information hallucination. This occurs when an LLM response omits information that should have been provided in the LLM response if the LLM response was to be fully responsive to the NL based input 210. For example, where the NL based input 210 is of a type indicative of a summarization task (e.g., a task in which the LLM is to summarize text indicated to the LLM in the NL based input 210), a missing information hallucination may occur when the LLM response does not include in its summarization all of the key information indicated in the NL based input 210 (i.e., the LLM response omits key information that should have been included in the LLM response).

There are various mechanisms by which the hallucination detection engine 150 may determine whether a candidate LLM response (such as the first LLM response 230) contains at least one hallucination, examples of which are set out below. The hallucination detection engine 150 may use any number of these mechanisms, in any order or combination, to determine whether the first LLM response 230 (or another LLM response) contains at least one hallucination. It should be understood that the following mechanisms by which the hallucination detection engine 150 may determine whether an LLM response contains at least one hallucination are provided by way of example and that additional and/or alternative mechanisms may be used, alone or in combination.

One example mechanism by which the hallucination detection engine 150 may determine whether an LLM response contains at least one hallucination involves the hallucination detection engine 150 determining a tense of the NL based input 210, determining a tense of the LLM response (e.g., the first LLM response 230), and performing a comparison between the determined tense of the NL based input 210 and the determined tense of the LLM response. A mismatch between the tense of the NL based input 210 and the tense of the LLM response may be indicative of the LLM response containing a hallucination (e.g., the LLM response may contain a hallucination if the tense of the first LLM response 230 does not correspond to the tense of the NL based input 210). As an example, the hallucination detection engine 150 may determine a tense of the NL based input 210 by, for example, identifying one or more verbs contained in the NL based input 210 and determining the tense of NL based input based on a determined tense of the one or more verbs. In such an example, the hallucination detection engine 150 may also determine the tense of the LLM response based on identifying one or more verbs contained in the LLM response and determining the tense of the LLM response based on a determined tense of the one or more verbs. The hallucination detection engine 150 may compare the tense of the NL based input 210 with the tense of the LLM response 230. If it is determined that the tenses match (e.g., they are the same tense), then it may be determined that the first LLM response 230 does not contain a hallucination, or rather it does not contain an incorrect tense hallucination error. If it is determined that the tenses do not match (e.g., they are different tenses), then it may be determined that the first LLM response 230 does contain a hallucination (in this example, an incorrect tense hallucination).

As another example mechanism for detecting a hallucination, the hallucination detection engine 150 may determine whether the first candidate response 230 (or another LLM response) contains one or more predetermined characters, one or more predetermined words, and/or one or more predetermined sequences of words. The predetermined characters, words and/or sequences of words may have been stored in the hallucination evaluation data database 150A prior to generation of the first LLM response 230. The one or more predetermined characters, words, and/or sequences of words may be characters, words or sequences of words that, if present in an LLM response, are indicative of the LLM response containing a hallucination. As an example, it may be determined whether the first LLM response 230 contains the sequence of words “the user” or “the system”, which may be indicative of the presence of an explicit speaker hallucination. As an additional or alternative example, it may be determined whether the first candidate response 230 contains the words “summary” or “summarized”, or the character “*” (indicative of a bullet point), any of which may be indicative of an annotation hallucination being present in the LLM response.

As another example mechanism for detecting a hallucination, the hallucination detection engine 150 may determine whether the first candidate response 230 (or another LLM response) contains a hallucination based on a type of task indicated by the NL based input 210 (e.g., a type of task that the LLM has been instructed to perform by the NL based input 210, such as a summarization task). For example, the hallucination detection engine 150 may process the NL based input 210 to determine a type of task indicated in the NL based input 210 that is to be performed by the LLM. The determination may be performed using any suitable form of classification technique or identification technique, for example. The hallucination detection engine 150 may then determine whether the first LLM response 230 contains at least one hallucination based on the type of task identified. For example, the hallucination detection engine 150 may determine, based on the identified type of task, one or more key slots that must be contained in the first LLM response 230 if the first LLM response 230 is to be considered responsive to the NL based input 210 (and therefore not to contain a hallucination). The one or more key slots may have been previously stored in the hallucination evaluation data database 150A.

As a specific illustration, based on an NL based input 210 of “How can I drive to Hamilton?”, the hallucination detection engine 150 may determine that the NL based input 210 corresponds to a ‘navigation’ type of task and, as such, the NL based response system 120 may determine that the first LLM response 230 should include at least one key slot corresponding to a ‘destination location’ if the first LLM response 230 is to be considered responsive to the NL based input 210. Put another way, the NL based response system 120 has determined that the first LLM response 230 should at least include at least one value corresponding to a destination location. The hallucination detection engine 150 may determine whether the first LLM response 230 contains a hallucination based at least in part on whether the first LLM response 230 includes a value corresponding to the destination location key slot. If the hallucination detection engine 150 determines that the first LLM response 230 does contain a value corresponding to a destination location (e.g., the first LLM response 230 is “You can drive to Hamilton via the M6 and the M74”, which contains a destination location key slot value of “Hamilton”), it may determine that the first LLM response 230 does not contain a hallucination (or rather, does not contain a missing information hallucination). On the other hand, if the hallucination detection engine 150 determines that the first LLM response 230 does not contain a value for the destination location key slot (e.g., the non-responsive, first LLM response 230 is “Driving can be an enjoyable activity” and therefore does not contain a destination location key slot value), it may determine that the first LLM response 230 contains a hallucination (e.g., a missing information hallucination).

As another example, if the task type is determined to be ‘order food’, the hallucination detection engine 150 may determine whether the first LLM response 230 contains a hallucination based at least in part on whether the first LLM response 230 includes at least one key slot value corresponding to a ‘menu item’ key slot and at least one key slot value corresponding to a ‘restaurant name’ key slot. If the hallucination detection engine 150 determines that the first LLM response 230 does not contain at least one key slot value corresponding to a ‘menu item’ and at least one key slot value corresponding to a ‘restaurant name’, it may determine that the first LLM response 230 contains a hallucination. On the other hand, if the hallucination detection engine 150 determines that the first LLM response 230 contains at least one key slot value corresponding to a ‘menu item’ and at least one key slot value corresponding to a ‘restaurant name’, it may determine that the first LLM response 230 does not contain a hallucination (or at least, does not contain a missing information hallucination).

One or more other example mechanisms for the hallucination detection engine 150 to detect a hallucination in a first LLM response 230 may include statistical analysis of the first LLM response 230 (or another LLM response). In some such examples, the hallucination detection engine 150 may determine whether the first LLM response 230 contains a hallucination based on the NL based input 210 and a length of the first LLM response 230. For instance, the hallucination detection engine 150 may determine that the first LLM response 230 contains a hallucination if a length of the first LLM response 230 exceeds a maximum length threshold value, wherein the maximum length threshold value may have been determined based on the NL based input 210. For example, the hallucination detection engine 150 may process the NL based input 210 to determine a maximum length threshold value for the LLM response (e.g., based on a type of task indicated by the NL based input 210 and/or one or more key slots associated with the NL based input 210), the maximum length threshold value indicating a length of an LLM response that, if exceeded by the first LLM response 230, indicates that the first LLM response 230 is too long to be responsive to the NL based input 210 (e.g., for the particular type of task and/or key slots), and therefore that the first LLM response 230 contains a hallucination (e.g. a superfluous information hallucination). For instance, an NL based input 210 indicating a task type that requires a relatively large number of key slots to be provided in the first LLM response 230 would likely be associated with a greater maximum length threshold value than an NL based input 210 indicating a task type that requires a relatively small number of key slots to be provided in the first LLM response 230.

Additionally, or alternatively, in some examples the hallucination detection engine 150 may determine that the first LLM response 230 contains a hallucination if a length of the first LLM response 230 does not meet a minimum length threshold value, where the minimum length threshold value may have been determined based on the NL based input 210. For example, the hallucination detection engine 150 may process the NL based input 210 to determine a minimum length threshold value for the LLM response (e.g., based on a type of task indicated by the NL based input 210 and/or one or more key slots associated with the NL based input 210), the minimum length threshold value indicating a length of an LLM response that, if not met or exceeded by the first LLM response 230, indicates that the first LLM response 230 is too short to be responsive to the NL based input 210 (e.g., for the particular type of task and/or key slots) and therefore that the first LLM response 230 contains a hallucination (e.g. a missing information hallucination).

Responsive to a determination at block 240, and using the hallucination detection engine 150, that the first LLM response 230 does not contain a hallucination, the first LLM response 230 can be selected by the response selection engine 152 as a selected response 250. The first LLM response 230 may be determined not to contain a hallucination if none of the mechanisms by which the hallucination detection engine 150 may determine whether the first LLM response 230 contains at least one hallucination has resulted in a determination that the first LLM response 230 contains a hallucination. To determine whether the first LLM response 230 contains at least one hallucination, the hallucination detection engine 150 may have performed any number or combination of the hallucination detection techniques disclosed herein and/or additional hallucination detection techniques.

The selected response 250 can be provided for rendering at the client device 110 (or another client device), for example, using the rendering engine 112 of FIG. 1. The selected response 250 may be caused to be rendered at the client device 110 (or the other client device) by the NL based response system 120 transmitting data to the client device 110 (or the other client device) that is operable for causing the client device 110 (or the other client device) to render the selected response 250.

However, responsive to a determination at block 240, and using the hallucination detection engine 150, that the first LLM response 230 does contain at least one hallucination, the NL based response system 120 may cause a new candidate LLM response (hereafter a subsequent LLM response 260) to be generated by processing the NL based input 210, and in lieu of selecting and rendering the first LLM response 230 as the selected response 250. The first LLM response 230 may be determined to contain at least one hallucination if at least one of the mechanisms by which the hallucination detection engine 150 determines whether the first LLM response 230 contains at least one hallucination has resulted in a determination that the first LLM response 230 contains a hallucination.

The NL based response system 120 can generate the subsequent LLM response 260 in the same or similar manner to generating the first LLM response 230. More specifically, the NL based response system 120 (e.g., the LLM engine 142 of FIG. 1) can generate the subsequent LLM response 260 based on processing the NL based input 210 using the LLM (e.g., the LLM stored in the LLM(s) database 142A of FIG. 1), for example via an LLM API or LLM frontend.

In some instances, processing the NL based input 210 using the LLM to generate the subsequent LLM response 260 may comprise providing the NL based input 210 (i.e., the same NL based input 210 used to generate the first LLM response 230) to the LLM used to generate the first LLM response 230 (or a different LLM to the LLM used to generate the first LLM response 230, such as a different LLM stored in the LLM(s) database 142A of FIG. 1), such as one that is more computationally intensive, but less prone to hallucinations. Due to the probabilistic nature of LLMs, the subsequent LLM response 260 may differ from the first LLM response 230, despite being generated based on the same NL based input 210 as the first LLM response 230.

In other instances, processing the NL based input 210 using the LLM to generate the subsequent LLM response 260 may comprise modifying the NL based input 210 using the input modification engine 144 to generate a modified NL based input and processing the modified NL based input using the LLM. Modifying the NL based input 210 may include, for example, deleting a portion of the NL based input 210 and/or adding to the NL based input 210 to generate the modified NL based input. The NL based input 210 may be modified using input modification data stored in the input modification data database 144A. The NL based input 210 may be modified in order to guide the LLM into generating a subsequent LLM response 260 that is less likely to contain a hallucination than the first LLM response 230. In some examples, modifying the NL based input 210 may be based on a type of hallucination contained in the first LLM response 230 that has been identified by the hallucination detection engine 150. As an example, responsive to the hallucination detection engine 150 identifying an incorrect tense hallucination, the input modification engine 144 may modify the NL based input 210 so as to reduce the likelihood of an incorrect tense hallucination appearing in the subsequent LLM response 260, for example, by adding an LLM prompt to the NL based input 210 to guide the LLM to provide an LLM response in a particular tense. As another example, responsive to the hallucination detection engine 150 identifying the presence of a missing information hallucination (e.g., based on the first LLM response 230 containing values for only two out of three expected key slots), the input modification engine 144 may modify the NL based input 210 so as to reduce the likelihood of missing information hallucination appearing in the subsequent LLM response 260, for example, by adding an LLM prompt to the NL based input 210 to explicitly inform the LLM of the three key input slots that are to be provided in the subsequent LLM response 260.

After the subsequent LLM response 260 has been generated, the subsequent LLM response 260 may be processed by the hallucination detection engine 150 of the NL based response system 120 to determine whether the subsequent LLM response 260 contains at least one hallucination. The hallucination detection engine 150 may determine whether the subsequent LLM response 260 contains at least one hallucination in the same or a similar manner as described in relation to the first LLM response 230, for example, using any mechanism or combination of hallucination detection mechanisms described herein.

Responsive to a determination using the hallucination detection engine 150 that the subsequent LLM response 260 does not contain any hallucinations (e.g., in a similar manner as described in relation to the first LLM response 230), the subsequent LLM response 260 can be selected as the selected response 250 using the response selection engine 152. Furthermore, the selected response 250 can be provided for rendering at the client device 110 (or another client device), for example, using the rendering engine 112 of FIG. 1. The selected response 250 may be caused to be rendered at the client device 110 (or the other client device) by the NL based response system 120 transmitting data to the client device 110 (or the other device) that is operable for causing the client device 110 (or the other device) to render the selected response 250.

However, responsive to a determination at block 240 using the hallucination detection engine 150 that the subsequent LLM response 260 does contain a hallucination (e.g., in a similar manner as described in relation to the first LLM response 230), the NL based response system 120 may cause a further LLM response (e.g., a new subsequent LLM response 260) to be generated. Generation of the new subsequent LLM response 260 may be performed in a same or a similar manner as described for generating the first LLM response 230 and/or subsequent LLM response 260. After the new subsequent LLM response 260 has been generated, it can then be determined by the NL based response system 120 whether the new subsequent LLM response 260 contains a hallucination, for example in the same or similar manner as described in relation to the first LLM response 230 and/or subsequent LLM response 260.

The process of generating a new subsequent LLM response 260 and determining whether the new subsequent LLM response 260 contains a hallucination may be repeated until one or more termination criteria are satisfied. One termination criterion may be a positive determination that a generated LLM response (such as the first LLM response 230 or a subsequent LLM response 260) does not contain a hallucination, at which point that LLM response may be selected by the response selection engine 152 as the selected response 250 and be caused to be rendered by the client device 110 (or another client device).

Additionally, or alternatively, a termination criterium may be that a threshold number of LLM responses have been generated, wherein the LLM responses include the first LLM response 230 generated based on a particular NL based input 210 and any subsequent LLM responses 260 that have been generated based on that particular NL based input 210. In such an example, a counter may be incremented each time a LLM response is generated. After each positive determination at block 240 that a LLM response contains one or more LLM hallucinations, a determination may be performed by the NL based response system 120 as to whether the counter meets a threshold value. If the threshold value is not met, the process flow 200A may continue, with a new subsequent LLM response 260 being generated. On the other hand, if the threshold value is met, the process flow 200A may terminate without generating a new subsequent LLM response 260. In such a scenario, the NL based response system 120 may cause an error output to be audibly and/or visibly rendered at the client device 110 to indicate to a user that a satisfactory response to the NL based input 210 (i.e. an LLM response without a hallucination) has not been generated.

Another example of a termination criterion is whether a timer has met a threshold time value. For example, a timer may be initiated responsive to receipt of the NL based input 210 (or at another stage of the process flow 200A). If the timer reaches a threshold time value (for example, 10 seconds) without an LLM response being generated that has been determined not to contain a hallucination, the process flow 200A may be terminated. In such a scenario, the NL based response system 120 may cause an error output to be audibly and/or visibly rendered at the client device 110 to indicate to a user that a satisfactory response to the NL based input 210 (i.e. a response without a hallucination) has not been generated within the threshold time value and/or cause a last LLM response that was generated to be audibly and/or visibly rendered at the client device 110 (and optionally with an indication that the LLM response includes the hallucination).

Turning now to FIG. 2B, another example process flow 200B for generating a response to a NL based input using an NL based response system (e.g., the NL based response system 120 from FIG. 1) is depicted. The example process flow 200B of FIG. 2B is similar to the example process flow 200A described in relation to FIG. 2A. However, as shown in FIG. 2B, the NL based input 210 is processed by the NL based response system 120 using an LLM to generate a plurality of LLM responses that form a set of LLM responses 235.

As shown in FIG. 2B, an NL based input 210 can be obtained, for example in the same or a similar manner as described in relation to process flow 200A of FIG. 2A. The NL based input 210 can be provided to the NL based response system 120 in order to obtain an LLM response that is responsive to the NL based input 210. For instance, the NL based input 210 can include a query or a prompt. In some implementations, the NL based input 210 can include an intent to complete a particular task, for instance, to be fulfilled by an automated assistant that is communicatively coupled to the NL based response system 120 (e.g., via the network(s) 199).

The NL based input 210 can be processed using the NL based response system 120. More specifically, the NL based response system 120 (e.g., via the LLM engine 142 of FIG. 1) can generate a plurality of candidate LLM responses based on processing the NL based input 210 using an LLM (e.g., an LLM stored in the LLM(s) database 142A of FIG. 1). The plurality of candidate LLM responses together form a set of LLM responses 235. Processing the NL based input 210 to generate the set of LLM responses 235 may be performed, for example, in the same or a similar manner to processing an NL based input 210 to generate a first candidate response 230 as described in relation to FIG. 2A.

In some examples, the NL based response system 120 (e.g., via the LLM engine 142 of the NL based response system 120) may generate the set of LLM responses 235 by sending a request comprising the NL based input 210 to an LLM API (e.g., LLM API 165 of FIG. 1) associated with the LLM. As an example, the LLM API may comprise a remote procedure call (RPC) API or a RESTful API. The request sent to the API can be converted by the API into a query corresponding to the NL based input 210, which query can be sent to the LLM. Responsive to receiving the query, the LLM is caused to process the NL based input 210 to generate a set of LLM responses 235 that are responsive to the NL based input 210, and to output the generated set of LLM responses 235 to the NL based response system 120 via the LLM API.

In some implementations, at least one of the LLM and the LLM API may optionally also generate and provide to the NL based response system 120 a respective quality score for each response of the set of LLM responses 235, wherein the quality score is indicative of a quality of the respective response (e.g., indicative of a responsiveness of the response to the NL based input 210).

In some implementations, rather than generate the first LLM response 230 by sending a request comprising the NL based input 210 directly to an LLM API associated with the LLM, the NL based response system 120 may instead generate the set of LLM responses 235 by sending the NL based input 210 to an LLM frontend (e.g., LLM frontend 160 of FIG. 1) associated with the LLM, wherein the LLM frontend may communicate with the LLM via the LLM API to generate the set of LLM responses 235. In some examples, the LLM frontend may be implemented as a web-based service that is between the NL based response system 120 and the LLM API. The NL based response system 120 (e.g., the LLM engine 142 of the NL based response system 120) may generate the set of LLM responses 235 by sending the NL based input 210 to the LLM frontend, which in turn can generate a request comprising the NL based input 210 and send the request to the API. The request sent to the API can be converted by the API into a query corresponding to the NL based input 210, which query can be sent to the LLM. Responsive to receiving the query, the LLM is caused to process the NL based input 210 to generate the set of LLM responses 235 that are responsive to the NL based input 210, and to output the generated set of LLM responses 235 to LLM front end. The LLM frontend can in turn provide the received set of LLM responses 235 to the NL based response system 120. In some instances, at least one of the LLM frontend, the LLM API, and/or the LLM may be configured to generate and provide to the NL based response system 120 a respective quality score for each response of the set of LLM responses, the quality score being as described previously.

Since LLMs can be described as being probabilistic, each candidate LLM response in the set of LLM responses 235 generated by the LLM can differ from another candidate LLM response in the set of LLM responses 235 generated by the LLM, despite being generated based on the same NL based input 210. As such, it can be assumed that the extent to which a candidate LLM response in the set of LLM responses 235 generated by the LLM is actually responsive to the NL based input 210 will vary, as may the occurrence of one or more hallucinations in the LLM response. Each LLM response, in the set of LLM responses 235, can be evaluated by the NL based response system 120 using the hallucination detection engine 150 to determine at a block 240 whether it contains one or more LLM hallucinations. Each LLM response in the set of LLM responses 235 can be processed using the hallucination detection engine 150, for example, in the same or a similar manner as described previously in relation to FIG. 2A.

For each LLM response in the first set of LLM responses 235, the hallucination detection engine 150 processes the LLM response to determine whether it contains one or more LLM hallucinations. The hallucination detection engine 150 may use any mechanism or combination of mechanisms for determining whether an LLM response contains at least one hallucination, for example any of the mechanisms described with respect to process flow 200A of FIG. 2A. At step 245 it is determined whether all candidate LLM responses in the first set of LLM responses 235 have been processed by the hallucination detection engine 150 to determine whether they contain at least one hallucination. If, at step 245, it is determined that not all LLM responses in the first set of LLM responses 235 have been processed, the hallucination detection engine 150 continues processing the remaining LLM responses in the first set of LLM responses 235.

If, at step 245, it is determined that all candidate LLM responses in the first set of LLM responses 235 have been processed by the hallucination detection engine 150 to determine whether they contain at least one hallucination, the method proceeds to step 255.

At step 255, it is determined whether at least one LLM response from the first set of LLM responses 235 has been determined by the hallucination detection engine 150 not to contain at least one hallucination.

Responsive to a determination at step 255 that only a single LLM response of the first set of LLM responses 235 does not contain a hallucination, that LLM response can be selected by the response selection engine 152 as a selected response 250. Furthermore, the selected response 250 can be caused to be rendered at the client device 110 (or another client device), for example, using the rendering engine 112 of FIG. 1. The selected response 250 may be caused to be rendered at the client device 110 (or the other client device) by the NL based response system 120 transmitting data to the client device 110 (or the other client device) that is operable for causing the client device 110 (or the other client device) to render the selected response 250.

However, responsive to a determination, at step 255, that a plurality of LLM responses in the first set of LLM responses 235 do not contain a hallucination, at least one LLM response of that plurality of LLM responses determined not to contain a hallucination can be selected by the response selection engine 152 as the selected response 250 and caused to be rendered at the client device 110 (or the other client device). The response selection engine 152 may select one of the plurality of responses as the selected response 250 using any suitable technique. For example, the response selection engine 152 may select the first LLM response, of the plurality of LLM responses, that are determined by the hallucination detection engine 150 not to contain a hallucination as the selected response 250. In other examples, the response selection engine 152 may select the selected response 250 based on a determined quality of each of the plurality of LLM responses (e.g., and that also does not contain a hallucination). For instance, each LLM response, of the plurality of LLM responses, may have an associated quality score and the response selection engine 152 may select as the selected response 250 the LLM response, from among the plurality of LLM responses, that has a highest quality score. The quality scores may be the same quality scores that were optionally generated by the LLM, LLM API and/or LLM frontend as described previously, or the quality scores may have been newly generated by NL based response system 120 (optionally based at least in part by the quality scores that were optionally generated by the LLM, LLM API and/or LLM frontend). In other examples, the response selection engine 152 may perform a random or pseudo-random selection from among the plurality of responses to select the selected response 250. In some examples, the response selection engine 152 may filter the plurality of LLM responses based on one or more predetermined criteria (such as response length or response tone) and select one of the filtered LLM responses as the selected response 250. It should be understood that these techniques for selecting one of a plurality of LLM responses as the selected response 250 are provided by way of example and are not meant to be limiting. Rather, additional, or alternative techniques for selecting one of the plurality of LLM responses as the selected response 250 may be implemented. Furthermore, it should be noted that in some implementations, more than one of the plurality of LLM responses determined not to contain a hallucination may be selected as a selected response 250 and caused to be rendered at the client device 210.

On the other hand, responsive to a determination, at block 255, that none of the LLM responses in the first set of LLM responses 235 do not contain at least one hallucination (i.e., all of the LLM responses in the first set of LLM responses 235 do contain at least one hallucination), the NL based response system 120 may cause a new set of candidate LLM responses (hereafter referred to as a subsequent set of LLM responses 265) to be generated by processing the NL based input 210, in lieu of selecting and rendering an LLM response from among the first set of LLM responses 235 as a selected response 250.

The NL based response system 120 can generate the subsequent set of LLM responses 265 (which comprise a plurality of LLM responses), for example, in a similar manner to generating the first set of LLM responses 235. More specifically, the NL based response system 120 (e.g., the LLM engine 142 of FIG. 1) can generate the subsequent set of LLM responses 265 based on processing the NL based input 210 using the LLM (e.g., the LLM stored in the LLM(s) database 142A of FIG. 1), where the NL based input 210 is identical to the NL based input 210 processed to generate the first set of LLM responses 235. The LLM may be the same LLM used to process the first set of LLM responses 235, or it may be a different LLM (e.g., a different LLM stored in the LLM(s) database 142A of FIG. 1), such as one that is more computationally intensive, but less prone to hallucinations.

In some instances, processing the NL based input 210 using the LLM to generate the subsequent set of LLM responses 265 may comprise providing the NL based input 210 (i.e., the same NL based response 210 used to generate the first set of LLM responses 235) to the LLM used to generate the first set of LLM responses 235 (or a different LLM to the LLM used to process the first NL based input 210, such as a different LLM stored in the LLM(s) database 142A of FIG. 1). Due to the probabilistic nature of LLMs, the subsequent set of LLM responses 265 may differ from the first set of LLM responses 235, despite being generated based on the same NL based input 210 as the first set of LLM responses 235.

In other instances, processing the NL based input 210 using the LLM to generate the subsequent set of LLM responses 265 may comprise modifying the NL based input 210 using the input modification engine 144 to generate a modified NL based input and processing the modified NL based input using the LLM. Modifying the NL based input 210 may include, for example, deleting a portion of the NL based input 210 and/or adding to the NL based input 210 to generate the modified NL based input. The NL based input 210 may be modified using input modification data stored in the input modification data database 144A. The NL based input 210 may be modified in order to guide the LLM into generating a subsequent set of LLM responses 265 that are less likely to contain a hallucination found in the first set of LLM responses 235. In some examples, modifying the NL based input 210 may be based on at least one type of hallucination contained in at least one LLM response of the first set of LLM responses 235 that has been identified by the hallucination detection engine 150. As an example, responsive to the hallucination detection engine 150 identifying an incorrect tense hallucination in at least one LLM response of the first set of LLM responses 235, the input modification engine 144 may modify the NL based input 210 so as to reduce the likelihood of an incorrect tense hallucination appearing in the subsequent set of LLM responses 265, for example by adding an LLM prompt to the NL based input 210 to guide the LLM to provide LLM responses in a particular tense. As another example, responsive to the hallucination detection engine 150 identifying the presence of a missing information hallucination in at least one LLM response of the first set of LLM responses 235 (e.g., based on at least one LLM response of the first set of LLM responses 235 containing values for only two out of three expected key slots), the input modification engine 144 may modify the NL based input 210 so as to reduce the likelihood of missing information hallucination appearing in the subsequent set of LLM responses 265, for example by adding an LLM prompt to the NL based input 210 to explicitly inform the LLM of the three key input slots that are to be provided in each LLM response of the subsequent set of LLM responses 265.

After the subsequent set of LLM responses 265 has been generated, each LLM response in the subsequent set of LLM responses 265 may be processed by the hallucination detection engine 150 of the NL based response system 120 to determine whether the LLM response contains at least one hallucination, for example, in the same or a similar manner as previously described in relation to the first set of LLM responses 235, and using any mechanism or combination of hallucination detection mechanisms described herein.

At step 245 it is determined whether all candidate LLM responses in the subsequent set of LLM responses 265 have been processed by the hallucination detection engine 150 to determine whether they contain at least one hallucination. If, at step 245, it is determined that not all LLM responses in the subsequent set of LLM responses 265 have been processed, the hallucination detection engine 150 continues processing the remaining LLM responses in the subsequent set of LLM responses 265.

If, at step 245, it is determined that all candidate LLM responses in the subsequent set of LLM responses 265 have been processed by the hallucination detection engine 150 to determine whether they contain at least one hallucination, the method proceeds to step 255.

At step 255, it is determined whether at least one LLM response from the subsequent set of LLM responses 265 has been determined by the hallucination detection engine 150 not to contain at least one hallucination.

Responsive to a determination at step 255 that only a single LLM response of the subsequent set of LLM responses 265 does not contain a hallucination, that LLM response can be selected by the response selection engine 152 as a selected response 250. Furthermore, the selected response 250 can be caused to be rendered at the client device 110 (or another client device), for example using the rendering engine 112 of FIG. 1. The selected response 250 may be caused to be rendered at the client device 110 (or the other client device) by the NL based response system 120 transmitting data to the client device 110 (or the other client device) that is operable for causing the client device 110 (or the other client device) to render the selected response 250.

However, responsive to a determination, at step 255, that a plurality of LLM responses in the subsequent set of LLM responses 265 do not contain a hallucination, at least one LLM response of that plurality of LLM responses determined not to contain a hallucination can be selected by the response selection engine 152 as the selected response 250 and caused to be rendered at the client device 110 (or the other client device). The response selection engine 152 may select one of the plurality of responses using, for example, one or more of the techniques previously described in relation to selecting a selected response 250 using the response selection engine 152.

On the other hand, responsive to a determination, at block 255, that none of the LLM responses in the subsequent set of LLM responses 265 do not contain at least one hallucination (e.g., all of the LLM responses in the subsequent set of LLM responses 265 do contain at least one hallucination), the NL based response system 120 may cause another new set of candidate LLM responses (e.g., new subsequent set of LLM responses 265) to be generated by processing the NL based input 210, and in lieu of selecting and rendering an LLM response from among the subsequent set of LLM responses 265 as a selected response 250.

The NL based response system 120 can generate the new subsequent set of LLM responses 265 (which again comprise a plurality of LLM responses), for example, in the same or a similar manner to generating the previous subsequent set of LLM responses 265. The new subsequent set of LLM responses 265 can then be processed using the hallucination detection engine 150, for example, in the same or a similar manner to the previous subsequent set of LLM responses 235 in an attempt to identify and select an LLM response of the new subsequent set of LLM responses 265 for rendering.

The process of generating a new, subsequent set of LLM responses 265 and determining whether each LLM response, in the new, subsequent set of LLM responses 265, contains a hallucination may be repeated until one or more termination criteria are satisfied. One termination criterion may be a positive determination that a generated LLM response (such as an LLM response in the first set of LLM responses 235 or an LLM response in any of the subsequent sets of LLM responses 265) does not contain a hallucination, at which point that LLM response may be selected by the response selection engine 152 as the selected response 250 and be caused to be rendered by the client device 110 (or another client device).

Additionally, or alternatively, a termination criterium may be that a threshold number of sets of LLM responses have been generated, wherein the sets of LLM responses include the first set of LLM responses 235 generated based on a particular NL based input 210 and any subsequent sets of LLM responses 265 that have been generated based on that particular NL based input 210. In such an example, a counter may be incremented each time a set of LLM responses is generated. After each determination, at step 255, that all LLM responses within a set of LLM responses contain one or more LLM hallucinations, a determination may be performed by the NL based response system 120 as to whether the counter meets a threshold value. If the threshold value is not met, the process flow 200B may continue, with a new subsequent set of LLM responses 265 being generated. On the other hand, if the threshold value is met, the process flow 200B may terminate without generating a new subsequent set of LLM responses 265. In such a scenario, the NL based response system 120 may cause an error output to be audibly and/or visibly rendered at the client device 110 to indicate to a user that a satisfactory response to the NL based input 210 (i.e. an LLM response without a hallucination) has not been generated.

Another example of a termination criterion is whether a timer has met a threshold time value. For example, a timer may be initiated responsive to receipt of the NL based input 210 (or at another stage of the process flow 200B). If the timer reaches a threshold time value (for example, 10 seconds) without an LLM response being generated that has been determined not to contain a hallucination, the process flow 200B may be terminated. In such a scenario, the NL based response system 120 may cause an error output to be audibly and/or visibly rendered at the client device 110 to indicate to a user that a satisfactory response to the NL based input 210 (e.g., a response without a hallucination) has not been generated within the threshold time value and/or cause a last LLM response that was generated to be audibly and/or visibly rendered at the client device 110 (and optionally with an indication that the LLM response includes the hallucination).

Although it has generally been described in relation to FIG. 2A and FIG. 2B that the client device 110 to which the NL based input 210 is associated and the client device 110 which renders the selected response 250 are the same client device 110, in some implementations this may not be the case. In other words, the client device 110 which renders the selected response 250 can be a different client device 110 than the client device which provided the NL based input 210. For instance, the selected response 250 can be rendered on a display separate from (but possibly associated with, for instance, by virtue of a user account being signed in on both devices) a smart speaker which received the NL based input 210.

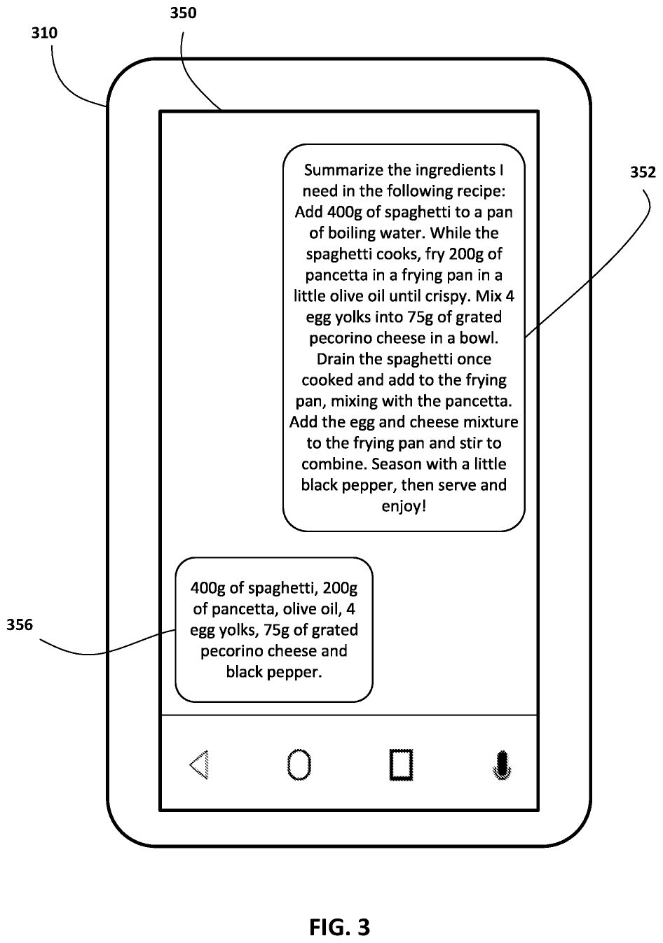

Referring to FIG. 3, a non-limiting example of generating an LLM response in accordance with one or more implementations is depicted. An example client device 310 (e.g., an instance of the client device 110 from FIG. 1) with a display 350 rendering a graphical interface is depicted. The graphical interface includes an NL based input 352 associated with the client device 310. For instance, a user of the client device 310 can provide the NL based input 352 (e.g., via touch or typed input received at a touch screen display of the client device 310, via spoken input captured in audio data generated by one or microphones of the client device 310, etc.). The NL based input 352 may have been provided, for example, in accordance with FIG. 1, FIG. 2A and/or FIG. 2B.

In the example of FIG. 3, the user has provided an NL based input 352 of “Summarize the ingredients I need in the following recipe: Add 400 g of spaghetti to a pan of boiling water. While the spaghetti cooks, fry 200 g of pancetta in a frying pan in a little olive oil until crispy. Mix 4 egg yolks into 75 g of grated pecorino cheese in a bowl. Drain the spaghetti once cooked and add to the frying pan, mixing with the pancetta. Add the egg and cheese mixture to the frying pan and stir to combine. Season with a little black pepper, then serve and enjoy!”. The NL based input 352 therefore contains a recipe including a number of ingredients, and instructions for an LLM (e.g., an LLM stored in the LLM(s) database 142A of FIG. 1), to perform a summarization task to summarize the ingredients in the recipe.

The graphical interface also includes an LLM response 356 generated using an NL based response system (e.g., NL based response system 120). The response 356 has been generated based on processing the NL based input 352 using an LLM (e.g., an LLM stored in the LLM(s) database 142A of FIG. 1), in accordance with one or more implementations disclosed herein. The response 356 has been selected for rendering in response to a determination that the response 356 does not contain a hallucination, in accordance with one or more implementations disclosed herein. In the example shown in FIG. 3, the response 356 recites “400 g of spaghetti, 200 g of pancetta, olive oil, 4 egg yolks, 75 g of grated pecorino cheese and black pepper”. The response 356 is responsive to the NL based input 352 insofar as it contains a summary of each of the ingredients in the recipe provided by the user in the NL based input 352, without any additional or missing ingredients (e.g., without a superfluous information hallucination or a missing information hallucination being present).

Although the selected response 356 is the only LLM response shown in FIG. 3, it should be noted that any number of LLM responses may have been generated based on processing the NL based input 352, with the response 356 having been selected from the generated LLM responses for display based on a determination that the response 356 does not contain a hallucination. For example, an alternative LLM response (not shown) of “400 g of spaghetti, 200 g of pancetta, cream, olive oil, 4 egg yolks, 75 g of grated pecorino cheese and black pepper” may have been generated by the NL based response system 120 based on processing the NL based input 352, either as a first LLM response generated prior to the selected response 356, or as part of a set of LLM responses that also included the selected response 356. However, it may have been determined by the NL based response system 120 using any of the techniques disclosed herein that such an alternative LLM response contains a hallucination, since the alternative LLM response contains an additional ingredient “cream” that was not present in the original NL based input 352 (e.g., a superfluous information hallucination is present). As such, the alternative LLM response was not selected for rendering at the display 350, and the response 356 (which was determined to contain no such hallucinations) was selected for rendering instead. For example, response 356 may be selected based on response 356 being the first of the generated LLM responses determined not to contain a hallucination, based on response 356 being the only of the generated LLM responses not to contain a hallucination, or based on response 356 being selected from a plurality of LLM responses that were determined not to contain a hallucination.

Although the selected response 356 is depicted as being the only LLM response rendered at the graphical interface, it should be understood that is for the sake of example and is not meant to be limiting. Rather, it should be understood that, in various implementations, multiple LLM responses can be rendered. For example, in some examples where a plurality of LLM responses have been generated, the selected response 356 may be rendered with one or more of the other LLM responses in the plurality of LLM responses, but with the selected response 356 rendered more prominently than the other rendered LLM responses. In examples where more than one LLM response of a plurality of generated LLM responses has been determined not to contain a hallucination, those more than one response may be chosen as selected responses and be rendered at the client device 310, while any LLM responses determined to contain at least one hallucination are not rendered at the client device 310.

While FIG. 3 shows the NL based input 352 containing the entire text (in this case a recipe) to be summarized, this is not meant to be limiting. For example, in other examples the NL based input 352 may instead contain a pointer to the text to be summarized, such as a Uniform Resource Locator (URL) for a resource on a computer network that contains the text to summarized, a document that is attached by the user, and/or other text that may be summarized.

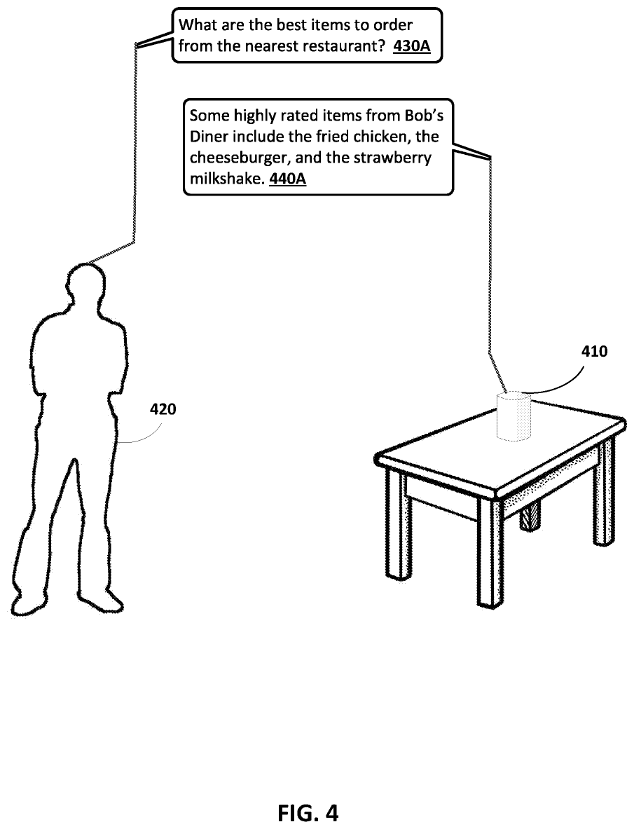

Referring now to FIG. 4, another non-limiting example of generating an LLM response in accordance with one or more implementations is depicted. An example client device 410 (e.g., an instance of the client device 110 from FIG. 1) taking the form of a smart speaker is shown. The client device 410 has one or more microphones to detect sounds and one or more speakers to output audio.

An NL based input 430A is associated with the client device 410. For instance, a user 420 of the client device 410 can provide the NL based input 430A using the client device 410 (e.g., via spoken input captured in audio data generated by one or microphones of the client device 410). The NL based input 430A may have been provided, for example, in accordance with FIG. 1, FIG. 2A and/or FIG. 2B. In the example of FIG. 4, the user 420 has provided the NL based input 430A of “What are the best items to order from the nearest restaurant?”.

The NL based input 430A is received by an NL based response system (e.g. the NL based response system 120 described in relation to FIG. 1). The NL based response system may be located remotely from the client device 410, with the client device 410 and the NL based response system communicatively coupled with each other via one or more networks 199 as described previously, such as one or more wired or wireless local area networks (“LANs”, including Wi-Fi®, mesh networks, Bluetooth®, near-field communication, etc.) or wide area networks (“WANs”, including the Internet). However, in other examples, one or more components of the NL based response system may be located within the client device 410.

Responsive to receiving the NL based input 430A associated with the client device 410, the NL based response system has processed the NL based input 430A using an LLM in accordance with any of the implementations disclosed herein (e.g., as described in relation to FIG. 1, FIG. 2A, or FIG. 2B) to generate an LLM response 440A of “Some highly rated items from Bob's Diner include the fried chicken, the cheeseburger, and the strawberry milkshake”, wherein the LLM response 440A has been selected for rendering responsive to a determination that it does not contain a hallucination, in accordance with any techniques disclosed herein. In this particular example, the NL based response system may have first generated an LLM response of “Bob's Diner is located at 123 Main Street” based on processing the NL based input using an LLM. In accordance with any techniques disclosed herein, the NL based response system (e.g., a hallucination detection engine 150 of FIG. 1) may have determined that the LLM response of “Bob's Diner is located at 123 Main Street” contains a hallucination because it does not contain a value corresponding to a menu item key slot. More specifically, the hallucination detection engine 150 may have determined that the NL based input 430A of “What are the best items to order from the nearest restaurant?” corresponds to a ‘food order’ task type and, as such, the LLM response is expected to at least contain a value corresponding to a ‘restaurant’ key slot and a ‘menu item’ key slot. The hallucination detection engine 150 may have processed the LLM response of “Bob's Diner is located at 123 Main Street” and determined that the LLM response contains a value of “Bob's Diner” that corresponds to the ‘restaurant’ key slot, but fails to contain a value corresponding to the ‘menu item’ key slot (because “123 Main Street” has not been identified as corresponding to a menu item). As a result, the hallucination detection engine 150 has determined that the NL based input 430A of “What are the best items to order from the nearest restaurant?” contains a hallucination and, in response, the NL based response system has caused a new LLM response to be generated based on the NL based input 430A of “What are the best items to order from the nearest restaurant?”.

Assume that the NL based response system (e.g., the input modification engine 144) has modified the NL based input 430A of “What are the best items to order from the nearest restaurant?” based on the identified hallucination to generate a modified NL based input of “What are the best items to order from the nearest restaurant? Your answer must contain at least a restaurant and a menu item”, wherein the modification has been made to prompt the LLM to provide an LLM output that conforms to the task type of the original NL based input 430A. Assume that, responsive to processing the modified NL based input, the LLM provides a new LLM response of “Some highly rated items from Bob's Diner include the fried chicken, the cheeseburger, and the strawberry milkshake, and the capital of Germany is Berlin” to the NL based response system. The hallucination detection engine 150 may determine that the new LLM response no longer contains a missing information hallucination since it now corresponds to the identified type of task (i.e., it now contains a value “Bob's Diner” corresponding to a restaurant key slot and a value “fried chicken” corresponding to a menu item key slot). However, the hallucination detection engine 150 may also have processed the new LLM response using a superfluous information detection mechanism. As a result, the hallucination detection engine 150 may have determined that the new LLM response contains superfluous information of “the capital of Germany is Berlin” that is not responsive to the NL based input 430A, and therefore that the new LLM response contains a (superfluous information) hallucination.

In response to determining that the new NL based input also contains a hallucination, the NL based response system has caused a further LLM response to be generated based on the NL based input 430A. Assume that to generate the further LLM response 440A, the NL based response system (e.g., the input modification engine 144 of FIG. 1) has modified the NL based input 430A to generate a further modified NL based input of “What are the best items to order from the nearest restaurant? Your answer must contain at least a restaurant and a menu item. Your answer must not include information about the capital of Germany”. Further assume that, responsive to processing the modified NL based input, the LLM provides as the further LLM response the LLM response 440A of “Some highly rated items from Bob's Diner include the fried chicken, the cheeseburger, and the strawberry milkshake” to the NL based response system. The hallucination detection engine 150 may determine that the new LLM response does not contain a missing information hallucination since it corresponds to the identified type of task (e.g., it contains a value “Bob's Diner” corresponding to a restaurant key slot and a value “fried chicken” corresponding to a menu item key slot), nor does it contain a superfluous information hallucination (e.g., it no longer includes information regarding the capital of Germany, or other superfluous information). Assume that the hallucination detection engine 150 has not identified any hallucinations in the LLM response 440. As such, the NL based response system has selected the LLM response 440 as the selected response and caused the LLM response 440 to be audibly rendered using a speaker of the client device 410, and in lieu of selecting and rendering either of the LLM responses that contain hallucinations.

By rendering only LLM responses that have been determined not to contain a hallucination, and not rendering LLM responses that have been determined to contain a hallucination, the amount of data to be rendered by the client device can be minimized, and computing resources can be conserved. In addition, by progressing through the process of generating new LLM responses and determining whether they contain a hallucination without further human interaction, resources (e.g., time and energy) in generating an appropriate LLM response can be conserved.

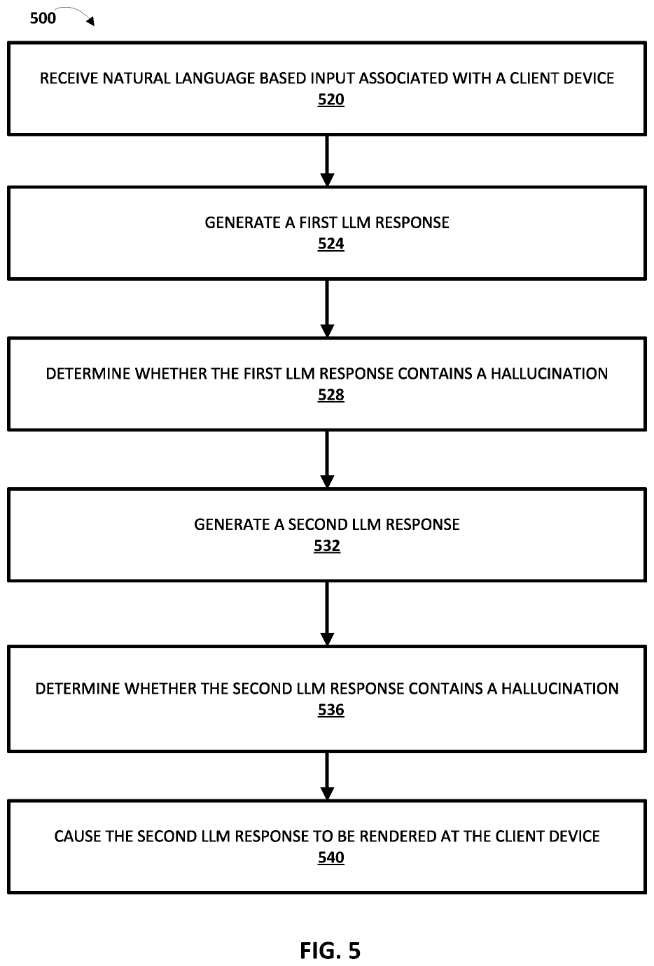

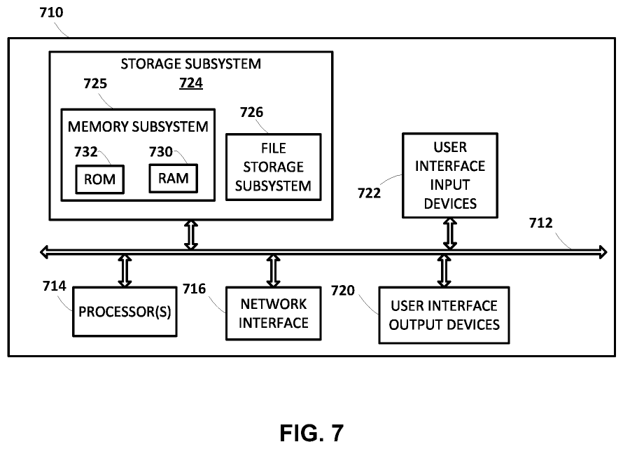

Turning now to FIG. 5, a flowchart illustrating an example method 500 of utilizing an NL based response system (e.g., the NL based response system 120 of FIG. 1) to generate a response to an NL based input associated with a client device (e.g., the client device 110 of FIG. 1), in accordance with various implementations, is depicted. For convenience, the operations of the method 500 are described with reference to a system that performs the operations. This system of the method 500 includes one or more processors, memory, and/or other component(s) of computing device(s) (e.g., client device 110 of FIG. 1, NL based response system 120 of FIG. 1, 2A or 2B, client device 310 of FIG. 3, client device 410 of FIG. 4, computing device 710 of FIG. 7, one or more servers, and/or other computing devices). Moreover, while operations of the method 500 are shown in a particular order, this is not meant to be limiting. One or more operations may be reordered, omitted, and/or added.

At block 520, the system receives a natural language (NL) based input associated with a client device (e.g., in the same or similar manner described with respect to FIG. 1, 2A, 2B, 3 or 4, and/or in other manners described herein).

At block 524, the system generates a first large language model (LLM) response based on processing the NL based input using an LLM (e.g., in the same or similar manner described with respect to FIG. 1, 2A, 2B, 3 or 4, and/or in other manners described herein).

At block 528, the system determines, based on processing the first LLM response, whether the first LLM response contains at least one hallucination (e.g., in the same or similar manner described with respect to FIGS. 1, 2A, 2B, 3, 4, and/or in other manners described herein).

At block 532, and responsive to determining at block 528 that the first LLM response contains at least one hallucination, the system generates a second LLM response based on processing the NL based input (e.g., in the same or similar manner described with respect to FIGS. 2A, 2B, and 2C, and/or in other manners described herein). In some examples, generating the second LLM response may comprises modifying the NL based input to generate a modified NL based input and processing the modified NL based input using the LLM or an alternative LLM (e.g., using a technique described with respect to FIG. 1, 2A, 2B, 3, or 4).

At block 536, the system determines whether the second LLM response contains at least one hallucination (e.g., in a same or similar manner described with respect to FIGS. FIG. 1, 2A, 2B, 3, or 4, and/or in other manners described herein).

At block 540, and responsive to determining at block 536 that the second LLM response does not contain at least one hallucination, the system causes the second LLM response to be rendered at the client device (e.g., in the same or similar manner described with respect to FIG. 1, 2A, 2B, 3, or 4, and/or in other manners described herein).

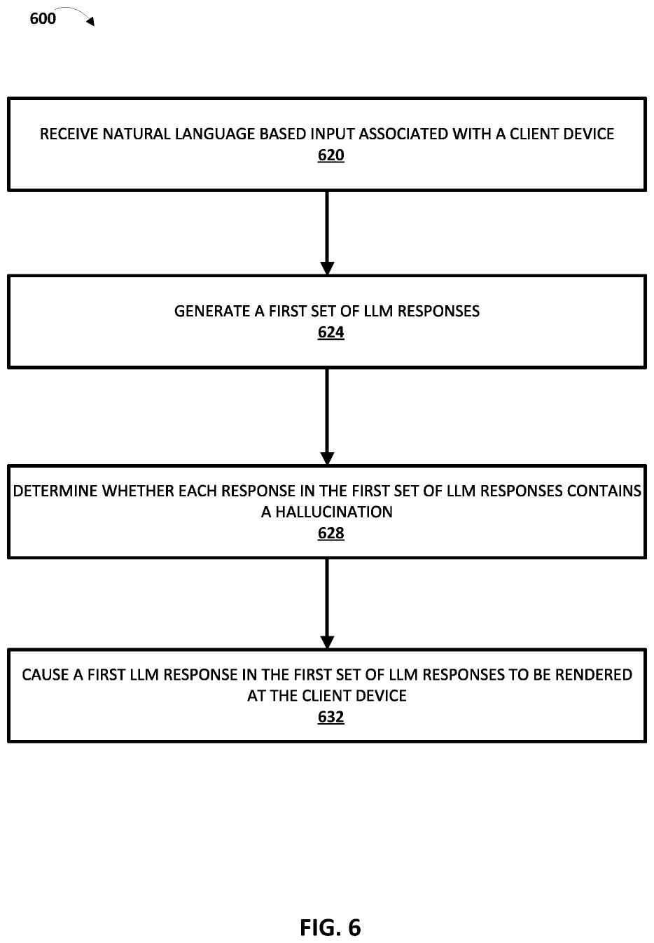

Turning now to FIG. 6, a flowchart illustrating another example method 600 of utilizing an NL based response system (e.g., the NL based response system 120 of FIG. 1) to generate a response to an NL based input associated with a client device (e.g., the client device 110 of FIG. 1), in accordance with various implementations, is depicted. For convenience, the operations of the method 600 are described with reference to a system that performs the operations. This system of the method 600 includes one or more processors, memory, and/or other component(s) of computing device(s) (e.g., client device 110 of FIG. 1, NL based response system 120 of FIG. 1, 2A or 2B, client device 310 of FIG. 3, client device 410 of FIG. 4, computing device 710 of FIG. 7, one or more servers, and/or other computing devices). Moreover, while operations of the method 600 are shown in a particular order, this is not meant to be limiting. One or more operations may be reordered, omitted, and/or added.

At block 620, the system receives an NL based input associated with a client device (e.g., in the same or similar manner described with respect to FIG. 1, 2A, 2B, 3 or 4, and/or in other manners described herein).

At block 624, and based on processing the NL based input using a large language model, the system generates a first set of LLM responses (e.g., in the same or similar manner described with respect to FIG. 1, 2A, 2B, 3 or 4, and/or in other manners described herein). The first set of LLM responses comprises a plurality of LLM responses.

At block 628, and based on processing each LLM response in the first set of LLM responses, the system determines whether each LLM response in the first set of LLM responses contains at least one hallucination (e.g., in the same or similar manner described with respect to FIGS. 1, 2A, 2B, 3, 4, and/or in other manners described herein).

At block 632, and responsive to determining at block 628 that at least a first LLM response in the first set of LLM responses does not contain at least one hallucination, the system causes the first LLM response to be rendered at the client device (e.g., in the same or similar manner described with respect to FIG. 1, 2A, 2B, 3, or 4, and/or in other manners described herein).

In some examples, at block 628 it may instead be determined by the system that each LLM response in the first set of LLM responses contains at least one hallucination. In response to such a determination, rather than proceeding to block 632, the system generates, based on processing the NL based input using the LLM, a second set of LLM responses. The system then determines, based on processing each LLM response in the second set of LLM responses, whether each LLM response in the second set of LLM responses contains at least one hallucination and, responsive to determining that an LLM response in the second set of LLM responses does not contain a hallucination, causes that LLM response to be rendered at the client device.

Turning now to FIG. 7, a block diagram of an example computing device 710 that may optionally be utilized to perform one or more aspects of techniques described herein is depicted. In some implementations, one or more of a client device, cloud-based automated assistant component(s) or other cloud-based software application component(s), and/or other component(s) can include one or more components of the example computing device 710.

Computing device 710 typically includes at least one processor 714 which communicates with a number of peripheral devices via bus subsystem 712. These peripheral devices can include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 can include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 can include the logic to perform selected aspects of the methods disclosed herein, as well as to implement various components depicted in FIG. 1.

These software modules are generally executed by processor 714 alone or in combination with other processors. Memory 725 used in the storage subsystem 724 can include a number of memories including a main random-access memory (RAM) 730 for storage of instructions and data during program execution and a read only memory (ROM) 732 in which fixed instructions are stored. A file storage subsystem 726 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem 712 can use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect or otherwise monitor personal information about users, or can make use of personal and/or monitored information), the users can be provided with an opportunity to control whether programs or features collect user information (e.g., information about a user's social network, social actions or activities, profession, a user's preferences, or a user's current geographic location), or to control whether and/or how to receive content from the content server that can be more relevant to the user. Also, certain data can be treated in one or more ways before it is stored or used, so that personal identifiable information is removed. For example, a user's identity can be treated so that no personal identifiable information can be determined for the user, or a user's geographic location can be generalized where geographic location information is obtained (such as to a city, ZIP code, or state level), so that a particular geographic location of a user cannot be determined. Thus, the user can have control over how information is collected about the user and/or used.

While it has been generally described in relation to techniques disclosed herein that a selected LLM response (that has been determined not to contain hallucinations) can be caused to be rendered (e.g., audibly and/or visibly) at a client device, it should be noted that this is disclosed by way of example. In some implementations, additionally or alternatively to causing the selected LLM response to be rendered (e.g., audibly and/or visibly), the selected LLM response may be transmitted by the NL based response system (e.g., the NL based response system 120 of FIG. 1) to a control system, such as a control system for controlling a robot. For example, the selected LLM response may be transmitted to the control system for controlling navigation of the robot (e.g., wherein the selected LLM response is processed by one or more processors of the robot control system to generate control instructions for one or more motors and/or actuators of the robot). In other examples, the control system may be for controlling an autonomous (i.e., self-driving) or semi-autonomous vehicle. For example, the selected LLM response may be transmitted to the control system for controlling navigation of the autonomous or semi-autonomous vehicle (e.g., wherein the selected LLM response is processed by one or more processors of the autonomous or semi-autonomous vehicle control system to generate control instructions for one or more motors and/or actuators of the autonomous or semi-autonomous vehicle).

In some implementations, a method implemented by one or more processors is provided, and includes receiving natural language (NL) based input associated with a client device; generating, based on processing the NL based input using a large language model (LLM), a first LLM response; determining, based on processing the first LLM response, whether the first LLM response contains at least one hallucination; responsive to determining that the first LLM response contains at least one hallucination, generating a second LLM response based on processing at least the NL based input; determining whether the second LLM response contains at least one hallucination; and responsive to determining that the second LLM response does not contain at least one hallucination, causing the second LLM response to be rendered at the client device.

These and other implementations can optionally include one or more of the following features.

In some implementations, the NL based input may include a request for the LLM to perform a summarization task.

In some implementations, generating the second LLM response may include modifying the NL based input to generate a modified NL based input and processing the modified NL based input, using the LLM or an alternative LLM, to generate the second LLM response.

In some versions of those implementations, the method may further include determining a type of hallucination contained in the first LLM response. Modifying the NL based input may be based on the type of hallucination.

In some implementations, the method may further include determining, based on processing the NL based input, a type of task to be performed by the LLM. Determining whether the first LLM response contains at least one hallucination may be performed based on the type of task.

In some implementations, causing the second LLM response to be rendered at the client device may include transmitting data to the client device that is operable for causing the client device to render the second LLM response.

In some implementations, determining whether the first LLM response contains at least one hallucination may be performed without using the LLM.

In some implementations, determining whether the first LLM response contains at least one hallucination may include comparing the first LLM response to the NL based input.

In some implementations, the method may further include determining a length of the first LLM response. Determining whether the first LLM response contains at least one hallucination may be based at least in part on the NL based input and the length of the first LLM response.

In some implementations, the method may further include determining a tense of the NL based input; and determining a tense of the first LLM response. Determining whether the first LLM response contains at least one hallucination may be based at least in part on a comparison between the tense of the NL based input and the tense of the first LLM response.

In some implementations, generating the first LLM response may include transmitting instructions to an LLM frontend, and receiving, from the LLM frontend, the first LLM response. The instructions may include the NL based input;

In some implementations, the method may further include, responsive to determining that the second LLM response contains at least one hallucination: generating a third LLM response; determining whether the third LLM response contains at least one hallucination; and responsive to determining that the third LLM response does not contain at least one hallucination, causing the third LLM response to be rendered at the client device.

In some implementations, a method implemented by one or more processors is provided, and includes receiving natural language (NL) based input associated with a client device; generating, based on processing the NL based input using a large language model (LLM), a first set of LLM responses; determining, based on processing each LLM response in the first set of LLM responses, whether each LLM response in the first set of LLM responses contains at least one hallucination; responsive to determining that a first LLM response in the first set of LLM responses does not contain a hallucination, causing the first LLM response to be rendered at the client device.

These and other implementations can optionally include one or more of the following features.

In some implementations, the method may further include responsive to determining that each LLM response in the first set of LLM responses contains at least one hallucination, generating, based on processing the NL based input using the LLM, a second set of LLM responses; determining, based on processing each LLM response in the second set of LLM responses, whether each LLM response in the second set of LLM responses contains at least one hallucination; and responsive to determining that a second LLM response in the second set of LLM responses does not contain a hallucination, causing the second LLM response to be rendered at the client device and in lieu of other first LLM responses in the first set of LLM responses.

In some implementations, determining whether each LLM response in the first set of LLM responses contains at least one hallucination may be performed without using the LLM.

In some implementations, determining whether each LLM response in the first set of LLM responses contains a hallucination may include comparing each LLM response in the first set of LLM responses to the NL based input.

In some implementations, generating the first set of LLM responses may include: sending the NL based input to the LLM via an LLM application programming interface (API); and receiving the first set of LLM responses from the LLM via the LLM API. Each LLM response in the first set of LLM responses may have an associated quality score indicative of the responsiveness of the respective LLM response to the NL based input, and the selected LLM response may not have the highest quality score from among the set of LLM responses and in lieu of other second LLM responses in the second set of LLM responses.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving natural language (NL) based input associated with a client device;
generating, based on processing the NL based input using a large language model (LLM), a first LLM response;
determining, based on processing the first LLM response, whether the first LLM response contains at least one hallucination;
responsive to determining that the first LLM response contains at least one hallucination, generating a second LLM response based on processing at least the NL based input;
determining whether the second LLM response contains at least one hallucination; and
responsive to determining that the second LLM response does not contain at least one hallucination, causing the second LLM response to be rendered at the client device.

2. The method of claim 1, wherein the NL based input comprises a request for the LLM to perform a summarization task.

3. The method of claim 1, wherein generating the second LLM response comprises:
modifying the NL based input to generate a modified NL based input; and
processing the modified NL based input, using the LLM or an alternative LLM, to generate the second LLM response.

4. The method of claim 3, further comprising:
determining a type of hallucination contained in the first LLM response,
wherein modifying the NL based input is based on the type of hallucination.

5. The method of claim 1, further comprising:
determining, based on processing the NL based input, a type of task to be performed by the LLM,
wherein determining whether the first LLM response contains at least one hallucination is performed based on the type of task.

6. The method of claim 1, wherein causing the second LLM response to be rendered at the client device comprises transmitting data to the client device that is operable for causing the client device to render the second LLM response.

7. The method of claim 1, wherein determining whether the first LLM response contains at least one hallucination is performed without using the LLM.

8. The method of claim 1, wherein determining whether the first LLM response contains at least one hallucination comprises comparing the first LLM response to the NL based input.

9. The method of claim 1, further comprising:
determining a length of the first LLM response,
wherein determining whether the first LLM response contains at least one hallucination is based at least in part on the NL based input and the length of the first LLM response.

10. The method of claim 1, further comprising:
determining a tense of the NL based input; and
determining a tense of the first LLM response,
wherein determining whether the first LLM response contains at least one hallucination is based at least in part on a comparison between the tense of the NL based input and the tense of the first LLM response.

11. The method of claim 1, wherein generating the first LLM response comprises:
transmitting instructions to an LLM frontend, the instructions comprising the NL based input; and
receiving, from the LLM frontend, the first LLM response.

12. The method of claim 1, further comprising:
responsive to determining that the second LLM response contains at least one hallucination, generating a third LLM response;
determining whether the third LLM response contains at least one hallucination; and
responsive to determining that the third LLM response does not contain at least one hallucination, causing the third LLM response to be rendered at the client device.

13. A method implemented by one or more processors, the method comprising:
receiving natural language (NL) based input associated with a client device;
generating, based on processing the NL based input using a large language model (LLM), a first set of LLM responses;
determining, based on processing each LLM response in the first set of LLM responses, whether each LLM response in the first set of LLM responses contains at least one hallucination; and
responsive to determining that at least a first LLM response in the first set of LLM responses does not contain at least one hallucination, causing the first LLM response to be rendered at the client device and in lieu of other first LLM responses in the first set of LLM responses.

14. The method of claim 13, further comprising:
responsive to determining that each LLM response in the first set of LLM responses contains at least one hallucination, generating, based on processing the NL based input using the LLM, a second set of LLM responses;
determining, based on processing each LLM response in the second set of LLM responses, whether each LLM response in the second set of LLM responses contains at least one hallucination;
responsive to determining that a second LLM response in the second set of LLM responses does not contain a hallucination, causing the second LLM response to be rendered at the client device and in lieu of other second LLM responses in the second set of LLM responses.

15. The method of claim 13, wherein determining whether each LLM response in the first set of LLM responses contains at least one hallucination is performed without using the LLM.

16. The method of claim 13, wherein determining whether each LLM response in the first set of LLM responses contains a hallucination comprises comparing each LLM response in the first set of LLM responses to the NL based input.

17. The method of claim 13, wherein generating the first set of LLM responses comprises:
sending the NL based input to the LLM via an LLM application programming interface (API); and
receiving the first set of LLM responses from the LLM via the LLM API,
wherein each LLM response in the first set of LLM responses has an associated quality score indicative of the responsiveness of the respective LLM response to the NL based input, and
wherein the selected LLM response does not have the highest quality score from among the set of LLM responses.

18. A system comprising:
at least one processor; and
memory storing instructions that, when executed, cause the at least one processor to be operable to:
receive natural language (NL) based input associated with a client device;
generate, based on processing the NL based input using a large language model (LLM), a first LLM response;
determine, based on processing the first LLM response, whether the first LLM response contains at least one hallucination;
responsive to determining that the first LLM response contains at least one hallucination, generate a second LLM response based on processing at least the NL based input;
determine whether the second LLM response contains at least one hallucination; and
responsive to determining that the second LLM response does not contain at least one hallucination, cause the second LLM response to be rendered at the client device.
